(19) United States
(12) Patent Application Publication
(10) Pub. No.: US 2014/0245999 A1
(43) Pub. Date: Sep. 4, 2014

(54) METHOD FOR COOLING COMPRESSED CHARGE AIR OF A TURBOCHARGED INTERNAL COMBUSTION ENGINE

(71) Applicant: GE Jenbacher GmbH & Co OG, Jenbach (AT)

(72) Inventor: Friedrich GRUBER, Hippach (AT)

(73) Assignee: GE Jenbacher GmbH & Co OG, Jenbach (AT)

(21) Appl. No.: 14/273,777

(22) Filed: May 9, 2014

Related U.S. Application Data
(63) Continuation of application No. PCT/AT2012/000292, filed on Nov. 16, 2012.

(30) Foreign Application Priority Data
Nov. 18, 2011 (AT) 1714/2011

(51) Int. Cl. F02B 29/04

(52) U.S. Cl. CPC F02B 29/0406
USPC 123/568.12

(57) ABSTRACT

The invention relates to a method for cooling compressed charge air of a turbocharged internal combustion engine, wherein starting from a compression temperature the compressed charge air is cooled in a first cooling device to a first lowered temperature and in a subsequent second cooling device is cooled to a second lowered temperature which is lower than the first lowered temperature, wherein after the second cooling device the compressed charge air is cooled in a third cooling device to a third lowered temperature which is lower than the second lowered temperature, wherein the cooling or the compressed charge air in the third cooling device is effected only intermittently during operation of the internal combustion engine.

The present invention concerns a method of cooling a compressed charge air of a forced-induction internal combustion engine, wherein starting from a compression temperature the compressed charge air is cooled in a first cooling device to a first reduced temperature and in a subsequent second cooling device is cooled to a second reduced temperature lower than the first reduced temperature.

In regard to forced-induction internal combustion engines it is advantageous to cool the compressed charge air fed to the combustion chambers of the internal combustion engine, or a compressed fuel-air mixture. As cool air is of a greater density than warmer air filling of the combustion chambers and thus the displacement-specific power of the internal combustion engine can be increased with cool air. In that way the power limit of the internal combustion engine can be positively influenced by the intake temperature of the compressed charge air or the compressed fuel-air mixture being as low as possible.

Generally air or mixture cooling is effected at the present time in two stages, wherein in the first stage cooling of the mixture or the charge air is from about 200° C. to about 90° C. while in the second stage further cooling to about 50° C. is effected. The reason for that kind of cooling is that a large part of the mixture or charging air heat can be thereby incorporated into a heating circuit and can thus be put to use and overall only a relatively small amount of heat has to be dissipated into the environment.

The mixture or charging air temperature however cannot be reduced thereby to below the ambient temperature. That however would be advantageous for knock-free implementation of very high levels of engine power, for achieving very high compression ratios and for further reducing nitrogen oxide emissions.

Therefore the object of the invention is to provide a method which is improved over the state of the art of cooling a compressed charge air in forced-induction internal combustion engines, and a corresponding internal combustion engine.

According to the invention that object is attained by a method having the features of claim 1. Advantageous embodiments of the invention are recited in the appendant claims.

According to the invention it is therefore provided that after the second cooling device the compressed charge air is cooled in a third cooling device to a third reduced temperature lower than the second reduced temperature, wherein cooling of the compressed charge air in the third cooling device is effected only intermittently during operation of the internal combustion engine.

The term ‘charge air’ used in these configurations is not to be viewed as being limited to air, but also includes a fuel-air mixture.

The provision of three separate, series-connected charge air cooling devices or mixture cooling stages for three respectively different cooling circuits makes it possible to achieve further cooling of the charge air. In that way on the one hand very high levels of engine power can be produced without knock. On the other hand a further reduction in temperature of the compressed charge air permits very high compression ratios and further reductions in unwanted nitrogen oxide emissions. Thus it is possible in that way to achieve compression ratios of up to 15:1, which signifies a marked increase over the conventional compression ratios of between about 11:1 and 12:1.

It is provided that cooling of the compressed charge air in the third cooling device is effected only intermittently during operation of the internal combustion engine.

It can preferably be provided that during a power demand from the internal combustion engine greater than a predeterminable reference power, preferably the rated power of the internal combustion engine, the third cooling device is activated. For a so-called peak power mode of operation it can be provided that the cooling device which is the third one or the last one in the flow direction is only intermittently active, for example if the internal combustion engine is to deliver a power which is increased over a predeterminable reference power, for example the rated power, to a power network connected to the internal combustion engine by way of a generator. In that respect the definition of rated load or rated power can be an ongoing power output of the internal combustion engine which can be produced by the internal combustion engine without time limitations, without adversely affecting the service life or safety. It will be appreciated however that any power or load value can also be established as the predetermined reference value, with the third cooling device being activated as from the reference value being exceeded.

In a further advantageous variant it can be provided that the anti-knock property of an engine fuel gas fed to the internal combustion engine and/or to the charge air is detected, wherein the third cooling device is activated during a period in which the anti-knock property of the engine fuel gas lies below a predeterminable reference value.

The anti-knock property of an engine fuel gas is crucially determined by the proportion of higher-value (long-chain) hydrocarbons, a higher proportion thereof leading to a reduction in the anti-knock property. By ascertaining the gas composition, in particular the proportion of higher-value hydrocarbons, it is possible to determine the anti-knock property of the fuel gas. The methane number can be used as a common measurement of the anti-knock property of a fuel gas. It can therefore be provided that the methane number of the fuel gas is detected as a measurement of the anti-knock property of the fuel gas.

A deviation in the methane number can be detected by the occurrence of knocking. If knocking occurs suddenly and only intermittently it can be attributed with a high degree of probability to a worsening in the gas quality and thus a reduction in the methane number, in contrast to wear phenomena or deposits on the internal combustion engine, that lead to a creeping change in the knock limit. Knock occurring in the internal combustion engine can be detected in known fashion (for example by means of knock sensors) and the knock limit can be used as a measure in respect of the methane number, a reduction in the methane number leading to earlier attainment of the knock limit. The predeterminable reference value for the methane number can be derived in that case from the knock limit in normal operation of the internal combustion engine and can be ascertained for example when setting the internal combustion engine in operation.

For example the internal combustion engine can be a preferably stationary gas engine whose charge air contains natural gas. Now, with the proposed solution, during consumer peaks in which both the electric power tariff and also the gas tariff are very high, it is possible for a higher fluid gas proportion to be meteredly added to the natural gas or a correspondingly large amount of hydrogen can be added. At the same time the third cooling device can be activated during such consumer peaks, in which case the additional cooling of the charge air temperature implemented thereby prevents knocking engine operation and a maximum engine power level can be guaranteed.

The third cooling device can generally also be activated to avoid performance slumps during phases of high ambient temperature.

It can further be provided that cooling of the compressed charge air is effected in the third cooling device during acceleration of the internal combustion engine in order to speed up starting of the internal combustion engine from the cold condition.

A further reduction in the mixture temperature by the third cooling device can also be appropriate when during consumer peaks an engine fuel gas component of low anti-knock property is added to the fuel of the internal combustion engine. The further reduction in the mixture temperature can prevent knocking engine operation and maximum engine power can be guaranteed.

A particularly advantageous embodiment of the invention is that in which the compressed charge air is cooled in the first cooling device to a first reduced temperature of between 80° C. and 110° C., preferably 90° C. and the compressed charge air is cooled in the second cooling device to a second reduced temperature of between 40° C. and 60° C., preferably between 45° C. and 55° C., particularly preferably 50° C. It is particularly advantageous if it is provided that the compressed charge air is cooled in the third cooling device to a third reduced temperature of between 5° C. and 30° C., preferably between 20° C. and 25° C. In that case a cooling medium at a temperature in the region of between −5° C. and 20° C., preferably between 10° C. and 15° C., is used in the third cooling device.

In general the temperature levels of the cooling media for the individual cooling devices are different and can depend on the use or boundary conditions and on the demands involved.

For example the heat from the first cooling device can be used together with the heat from the engine exhaust gas for steam production, for example for water vapor processes, for steam production for industrial applications or for the operation of steam turbines by means of the Organic Rankine Cycle (ORC). For such cases the temperature of the cooling medium for the first cooling device is between about 110° C. and 120° C. In addition the heat of the first cooling device can be incorporated into heating circuits with a high feed temperature, for example heating circuits of district heating networks. A temperature of the cooling medium for the first cooling device of between about 100° C. and 110° C. would be optimum for that purpose. It can be provided generally that that heat which can be used at a high temperature level is taken from the compressed charge air in the first cooling device.

It can preferably be provided that cooling of the compressed charge air is effected in the first cooling device, using a coolant of a first cooling circuit of the internal combustion engine. The first cooling device can have an air-fluid heat exchanger and cooling of the compressed charge air can be effected in relation to the temperature of the coolant or cooling medium of the first cooling circuit. In that respect it can be provided that at least one cylinder liner and/or at least one cylinder head is or are also cooled by the first cooling circuit.

In a preferred embodiment it can be provided that cooling of the compressed charge air in the second cooling device is effected using ambient air. For that purpose the second cooling device can have an air-air heat exchanger, whereby cooling of the compressed charge air can be in relation to the ambient air temperature. The temperature of the compressed charge air can be reduced to a level of preferably between 45° C. and 55° C. by heat exchange with the ambient air. Preferably the internal combustion engine can be operated with that charge air or mixture temperature, in the predominant time.

A particularly advantageous embodiment of the invention is that in which cooling of the compressed charge air in the third cooling device is effected using a third cooling circuit separate from a first cooling circuit and a second cooling circuit. Therefore, besides a first cooling circuit, with the coolant or cooling medium of which, besides the compressed charge air, for example also cylinder liners or cylinder heads can be cooled, and a second cooling circuit in which for example ambient air can be used as the cooling medium, there can be a third cooling circuit which is separate therefrom and which has a separate cooling medium, providing for further cooling of the compressed charge air in the third cooling device.

Cooling the temperature of the compressed charge air in the third cooling device which can also be effected only short-term and for a limited time requires a cooling medium at a correspondingly low temperature. For example the following can be provided as cold reservoirs or cooling media suitable for that purpose:
natural water (temperature level about 15° C.),
chiller radiator by way of engine waste heat (temperature level about 0° C.),
storage cold (for example liquid air storage means, temperature level about 0° C.),
cold water storage means (cooling by way of refrigerating installations, temperature level about 5° C.),
process cold (for example in industrial applications), and
evaporation of a refrigerant (CO₂, ammonia, etc).

It can preferably be provided that water from a water storage means is used in the third cooling circuit as the cooling medium, wherein the water is cooled in the water storage means.

The minimum temperature of the cooling medium for the third cooling device however should not be less than about −5° C. to avoid icing of the heat exchanger surfaces in the third cooling device.

In a further variant it can be provided that after the third cooling device condensate which occurs by virtue of cooling of the compressed charge air to the third reduced temperature is separated off. In that way it is possible to prevent water condensate which occurs from passing into the combustion chambers of the internal combustion engine and causing damage.

The proposed solution is set forth hereinafter by means of specific examples and the economic advantages afforded by the invention are also set forth. It is assumed in that respect that the power of the engine can be increased by 20% by further cooling of the compressed charge air or the compressed fuel-air mixture in the third cooling device from 50° C. to 20° C.

Boundary condition (by way of example):
engine rated power (mixture temperature=50° C.): 1000 kW
peak load of the engine (mixture temperature=20° C.): 1200 kW
mixture volume flow at peak load: 6520 kg/h
thermal power to be removed from the third cooling device (cooling from 50° C. to 20° C.): 56 kW.

### Case 1:

Use of natural water (temperature level about 15° C.).
required amount of natural water (heating in the third cooling device: 10° C., that is to say from 15° C. to 25° C.): 4.8 m³/h
natural water costs: 2 [symbol] fsi/m³
duration of the peak load: 2 OH (operating hours) per day
natural water costs per day for peak load period: 19.2 [symbol] fsi
additional power production during the peak load period: 400 kW
natural water costs per kWh of additional power production: 4.8 [symbol] fsi ct/kWh
(average) electric power tariff outside peak load: 8 [symbol] fsi ct/kWh
electric power tariff during the peak load period: 20 [symbol] fsi ct/kWh
additional revenue due to the engine installation in the peak load period: about 7 [symbol] fsi ct/kWh or 28 [symbol] fsi in 2 OH peak load.

In the case of an annual total duration of the peak load periods of (assumed) 750 OH that gives an additional revenue of about 10,000 [symbol] fsi/year (the annual natural water costs of 4,800 [symbol] fsi are already deducted here).

### Case 2:

Use of cold water cooled in a heat storage mains by a refrigerating installation to about +10° C. In that respect it is provided that a cooling unit takes heat from a water storage means outside the peak tariff times. In that calculation by way of example the refrigerating assembly runs for 20 hours per day and in that time delivers 125 kWh of heat energy to the ambient air. The cooling assembly takes that amount of energy from the water cooling circuit (for example at 15° C.) and delivers it to the ambient air (at a temperature of for example 25° C.). As a result a feed temperature of 10° C. is available to the cooling circuit of the third mixture cooling stage. Inclusive of temperature spread in the heat exchangers a temperature difference of 40° C. thus has to be overcome. The electric power consumption for the refrigerating compressor of the cooling assembly is in that case about 0.4 kW.
energy costs for the refrigerating installation per day: 0.4 kW×20 h×0.06 [symbol] fsi/kWh=0.48 [symbol] fsi
duration of the peak load: 2 OH (operating hours) per day
additional electric power production during the peak load period: 400 kW
costs per additional electric power energy produced during the peak load period: 0.12 [symbol] fsi ct/kWh
(average) electric power tariff outside peak load: 8 [symbol] fsi ct/kWh
electric power tariff during the peak load period: 20 [symbol] fsi ct/kWh
additional revenue due to the engine installation in the peak load period: about 11 [symbol] fsi ct/kWh or 44 [symbol] fsi in 2 OH peak load.

With an annual total duration of the peak load periods of (assumed) 750 OH that gives an additional revenue of 16,000 [symbol] fsi/year. Therefore that variant is even more advantageous than case 1. Apart from a markedly better revenue potential no natural water consumption is also involved here, in which respect natural water is also not available everywhere.

Further details and advantages of the present invention will be described by means of the specific description hereinafter. In the drawing:

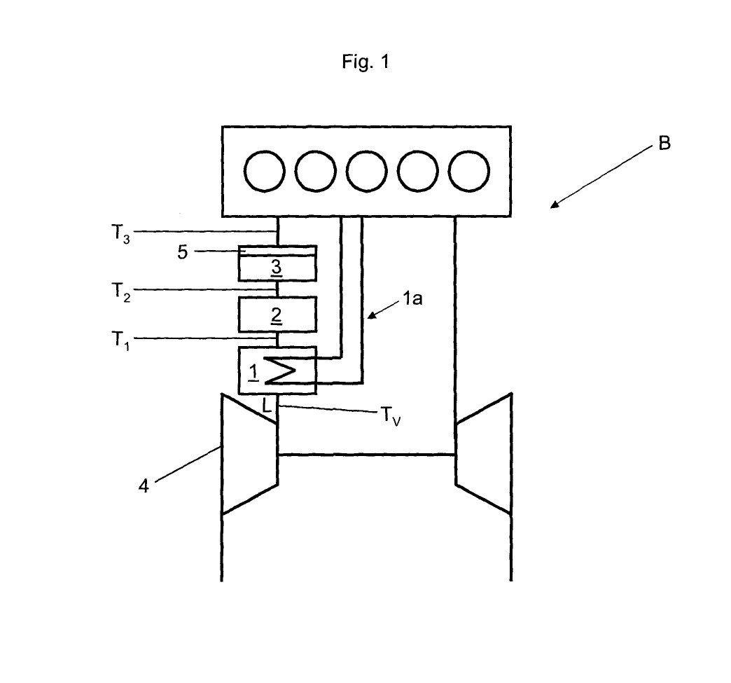

FIG. 1 shows a diagrammatic view of an internal combustion engine with three cooling devices,

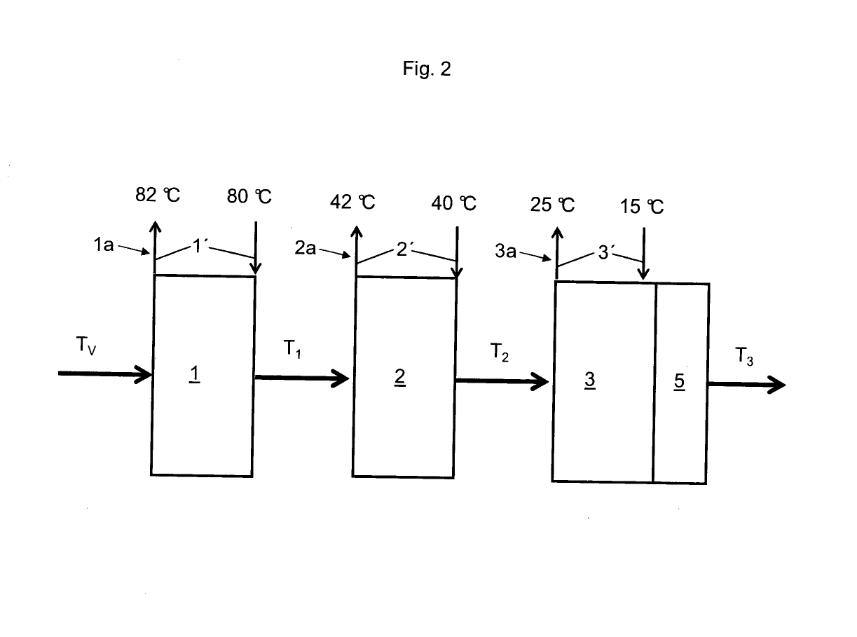

FIG. 2 shows a diagrammatic detail view of the three cooling devices of FIG. 1, and

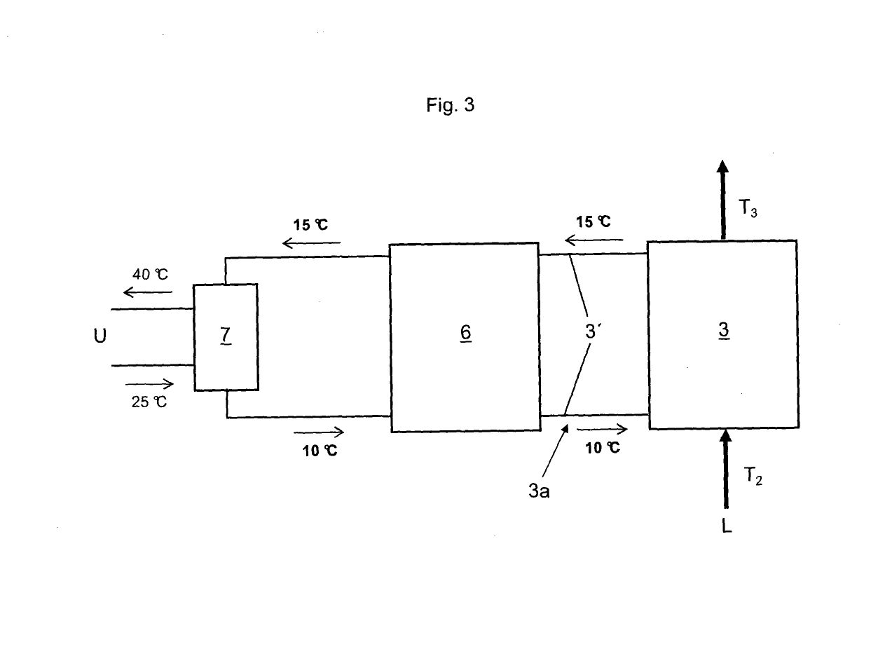

FIG. 3 shows a diagrammatic view of a third cooling device with a water storage means.

FIG. 1 shows a diagrammatic view of a proposed internal combustion engine B having three cooling devices 1, 2 and 3 and FIG. 2 shows a detail view of the three cooling devices 1, 2, 3. The internal combustion engine B in this example is a stationary, mixture-forced-induction gas engine having a charge air compressor 4 for compressing a fresh air fed to the internal combustion engine B.

The compressed charge air L is at a compression temperature Tᵥ of for example 230° C. and is passed through the first cooling device 1 of the internal combustion engine B. In that case a coolant 1′ of a first cooling circuit 1a of the internal combustion engine B can flow through the first cooling device 1. In that case the coolant 1′ of the first cooling circuit 1a can be fed at a temperature of 80° C. to the first cooling device 1 and after heat exchange with the compressed charge air 1 it can leave the first cooling device 1 again for example at a temperature of 82° C. Preferably it can also be provided that the first cooling circuit 1a of the internal combustion engine B can also cool at least one cylinder liner and/or at least one cylinder head of the internal combustion engine B. Overall for example the temperature of the compressed charge air L can be cooled by the first cooling device 1 from its compression temperature Tᵥ of for example 230° C. to a first reduced temperature T₁ of for example 100° C.

The compressed charge air L can be passed through the second cooling device 2, at that first reduced temperature T₁. In that respect it can preferably be provided that the second cooling device 2 can have ambient air flowing therethrough. In that case the coolant or cooling medium 2′ of the second cooling circuit 2a can therefore be ambient air which for example is fed to the second cooling device 2 at 40° C. and after heat exchange with the compressed charge air L (for example by radiator cooling) it leaves the second cooling device 2 again at a temperature of 42° C. The compressed charge air L can be cooled by the second cooling device 2 from its first reduced temperature T₁ downstream of the first cooling device 1 of for example 100° C. to a second reduced temperature T₂ of for example 50° C.

The compressed charge air L flows into the third cooling device 3 at that second reduced temperature T₂. In that respect it can preferably be provided that the third cooling device 3 has a third cooling circuit 3a which is separate from a first cooling circuit 1a and a second cooling circuit 2a. By means of the third cooling device 3 which can also be only intermittently activated, it is possible for the temperature of the compressed charge air L to be cooled down from its second reduced temperature T₂ to an even lower third reduced temperature T₃. The cooling medium 3′ used for the third cooling circuit 3a of the third cooling device 3 can be for example natural water at a temperature of about 15° C. After heat exchange with the compressed charge air L the natural water can leave the third cooling device 3 again at a temperature of for example 25° C. When the third cooling device 3 is activated, the temperature of the compressed charge air L can thereby be cooled down from a second reduced temperature T₂ of for example 50° C. to a third reduced temperature T₃ of for example 20° C. At that third reduced temperature T₃ the compressed charge air L or the compressed fuel-air mixture can then be introduced into the combustion chambers of the internal combustion engine.

In particular times of peak load demands can be economically used by only intermittent activation of the third cooling device 3. Normal operation of the internal combustion engine B outside the times of peak load can be implemented without the third cooling device 3 being activated in order not to unnecessarily increase the operating costs of the internal combustion engine B in those periods.

In addition the illustrated embodiment also has a condensate separator 5 by which a condensate which occurs due to cooling of the compressed charge air L in the third cooling device 3 can be separated off so that such condensate cannot pass into the combustion chambers of the internal combustion engine and cause damage there.

FIG. 3 shows an example of a third cooling device 3. The third cooling device 3 is connected to a third cooling circuit 3a using water from a water storage means 6 as the cooling medium 3′. To suitably cool down the cooling medium 3′ a cooling device 7 in the form of a refrigerating assembly is connected to the water storage means 6. For example the temperature of the cooling medium 3′ from the third cooling device 3 in the return is 15° C. The refrigerating assembly 7 now cools the cooling medium 3′ to a temperature of 10° C., at which the cooling medium 3′ is fed into the feed of the third cooling device 3 in order to cool down the compressed charge air L to a third reduced temperature T₃ of for example 20° C. To achieve suitable cooling of the cooling medium 3′ in the water storage means 6, the refrigerating assembly 7 in this case has a refrigerating compressor which delivers the heat energy taken from the cooling medium 3′ to the ambient air U. For that purpose in this example ambient air U is fed at a temperature of 25° C. to the refrigerating assembly 7 and after heat exchange the air is delivered to the environment again at a temperature of 40° C.

1. A method of cooling a compressed charge air of a forced-induction internal combustion engine, wherein starting from a compression temperature the compressed charge air is cooled in a first cooling device to a first reduced temperature and in a subsequent second cooling device is cooled to a second reduced temperature lower than the first reduced temperature, wherein after the second cooling device the compressed charge air is cooled in a third cooling device to a third reduced temperature lower than the second reduced temperature, wherein cooling of the compressed charge air in the third cooling device is effected only intermittently during operation of the internal combustion engine.

2. A method as set forth in claim 1, wherein during a power demand from the internal combustion engine greater than a predeterminable reference power, preferably the rated power of the internal combustion engine, the third cooling device is activated.

3. A method as set forth in claim 1, wherein the anti-knock property of an engine fuel gas fed to the internal combustion engine and/or to the charge air is detected, wherein the third cooling device is activated during a period in which the anti-knock property of the engine fuel gas lies below a predeterminable reference value.

4. A method as set forth in claim 3, wherein the methane number of the engine fuel gas is detected as a measurement for the anti-knock property of the engine fuel gas.

5. A method as set forth in claim 1, wherein cooling of the compressed charge air is effected in the third cooling device during acceleration of the internal combustion engine.

6. A method as set forth in claim 1, wherein cooling of the compressed charge air in the first cooling device is effected using a coolant of a first cooling circuit of the internal combustion engine, wherein it is preferably provided that at least one cylinder liner and/or at least one cylinder head is or are also cooled by the first cooling circuit.

7. A method as set forth in claim 1, wherein cooling of the compressed charge air in the second cooling device is effected using ambient air.

8. A method as set forth in claim 1, wherein cooling of the compressed charge air in the third cooling device is effected using a third cooling circuit separate from a first cooling circuit and a second cooling circuit.

9. A method as set forth in claim 8, wherein water from a water storage means is used in the third cooling circuit as the cooling medium, wherein the water is cooled in the water storage means.

10. A method as set forth in claim 1, wherein after the third cooling device condensate which occurs by virtue of cooling of the compressed charge air to the third reduced temperature is separated off.

11. A method as set forth in claim 1, wherein the compressed charge air is cooled in the first cooling device to a first reduced temperature of between 80° C. and 110° C., preferably 90° C.

12. A method as set forth in claim 1, wherein the compressed charge air is cooled in the second cooling device to a second reduced temperature of between 40° C. and 60° C., preferably between 45° C. and 55° C., particularly preferably 50° C.

13. A method as set forth in claim 1, wherein the compressed charge air is cooled in the third cooling device to a third reduced temperature of between 5° C. and 30° C., preferably between 20° C. and 25° C.

14. A method as set forth in claim 1, wherein a cooling medium at a temperature in the region of between −5° C. and 20° C., preferably between 10° C. and 15° C., is used in the third cooling device.
